(19) United States
(12) Patent Application Publication
(10) Pub. No.: US 2026/0219290 A1
(43) Pub. Date: Jul. 30, 2026

(54) HANDLING TOOL AND CLINICAL LAB AUTOMATION DEVICE INCLUDING THE SAME

(71) Applicant: Beckman Coulter Laboratory Systems (Suzhou) Co., Ltd., Suzhou, Jiangsu (CN)

(72) Inventors: Lidong FENG, Suzhou, Jiangsu (CN); Dongzhi NIU, Suzhou, Jiangsu (CN); Sebastian PYRSAK, Gorlice (PL)

(21) Appl. No.: 19/146,883

(22) PCT Filed: Jan. 10, 2023
(86) PCT No.: PCT/CN2023/071467

§ 371 Date: Jul. 9, 2025

(51) Int. Cl. G01N 35/00; B25J 15/00; G06F 3/0354; H04N 7/18; H04N 23/695

(52) U.S. Cl. CPC G01N 35/0099; B25J 15/0004; G06F 3/03545; H04N 7/18; H04N 23/695

(57) ABSTRACT

A handling tool for a clinical lab automation device, comprising two or more of the following: a form-fit gripper member for form-fit engaging and holding an object, particularly referred to as a first object; a friction-fit gripper member for frictionally engaging and holding an object, particularly referred to as a second object; a touch screen input member for inputting information into a touch screen; and a state-change member for changing the state of an object particularly referred to as a third object. A clinical lab automation device is also provided.

The present invention relates to a handling tool for a clinical lab automation device and a clinical lab automation device including said handling tool.

Scientific and technological research and experiments are typically performed in laboratories. Laboratories often include workstations for personnel and various pieces of equipment for performing the research and experiments. One particular type of laboratory is a clinical laboratory, herein also referred to as a clinical lab, wherein chemical or biological samples are processed. The equipment in a clinical lab can include DNA sequencers, dispensers, PCR (polymerase chain reaction) instruments, refrigeration units, transport carts, sample trays, and other types of equipment. In a typical clinical lab, human personnel can manually perform many of the various tasks needed for processing biological samples. Such tasks may include preparation of the chemical or biological samples, insertion and removal of samples into and from dispensers, DNA sequencers, PCR instruments, refrigeration units, and other equipment, transportation of samples between workstations and pieces of equipment, transporting samples between pieces of equipment, and recording data associated with the samples. The preparation of the samples may include, for example, extraction and purification, amplification and purification, and/or sequencing reaction. However, there are drawbacks to having personnel manually perform these tasks. For example, personnel can make mistakes due to inexperience, fatigue, and other factors. Such mistakes, such as placing the wrong samples in the equipment, incorrectly storing samples, and incorrectly recording data, could contaminate the samples and/or affect the results of DNA sequencing, for example. As another example, personnel performing these repetitive tasks may be better utilized doing other tasks that are more suited to their background and experience.

In the state of the art, it is known to automate specific tasks by a robot. However, there exists an opportunity for an improved system that can assist personnel to perform certain repetitive tasks in a clinical lab environment, in order to, among other things, obtain improved repeatability and optimized processing of samples and capture of more accurate data during scientific research and experiments.

In view of the above, it is an object of the present invention to provide a handling tool for a clinical lab automation device with improved efficiency, particularly working efficiency in a clinical lab environment.

Furthermore, it is an object of the present invention to provide a clinical lab automation device with improved efficiency, particularly working efficiency in a clinical lab environment.

The problem is solved by the subject-matter of the independent claims. Particular embodiments are defined by the dependent claims.

According to an aspect, a handling tool for a clinical lab automation device is provided, the handling tool comprising two or more of the following, in particular three or more of the following, and optionally all of the following:
a form-fit gripper member for form-fit engaging and holding an object, particularly referred to as a first object;
at least one friction-fit gripper member for frictionally engaging and holding an object, particularly referred to as a second object;
a touch screen input member for inputting information into a touch screen; and
a state-change member for changing the state of an object, particularly referred to as a third object.

The form-fit gripper member and the friction-fit gripper member are collectively also referred to as the gripper members, wherein reference to one of the gripper members accordingly means one of the form-fit gripper member and the friction-fit gripper member.

Owing to the handling tool which includes at least two of said different gripper members, a touch screen input member and a state-change member, the handling tool advantageously allows for automatic or at least semi-automatic processing of a plurality of tasks in a clinical lab environment, particularly of a plurality of subsequent tasks conducted on and/or with different objects in the clinical lab environment. Accordingly, the handling tool provides a clinical lab automation device with improved efficiency, particularly with improved working efficiency in the clinical lab environment.

The state-change member may particularly be configured to change the state of an object from a first state to a second state, and optionally from the second state to the first state. Utilizing the state-change member, the handling tool may for example be configured to change the state of a door of a refrigerator from closed to opened, and/or from opened to closed. Additionally or alternatively, the handling tool having the state-change member may for example be configured to adjust the temperature of a refrigerator and/or of a reaction chamber from a first temperature state to a second temperature state, to adjust the state of a tray of a shelf from closed to opened, and/or from opened to closed, and/or to manipulate a button, particularly a capacitive button, or manipulate or change the state of another element to be manipulated or state-changeable in a clinical lab.

With the touch screen input member, the handling tool is advantageously configured to operate a touch screen by e.g. inputting information into a touch screen. The information may be input into the touch screen by contacting the touch screen with the touch screen input member and/or contactless without touching the touch screen with the teach screen input member, for example capacitively, and/or via a visual signal, and/or via near field communication (NFC), for example. Additionally or alternatively, the information may be input by activating a reader connected to the touch screen by the touch screen input member, such as a barcode reader, a QR code reader, and/or an RFID reader, in order to scan and/or register a barcode, a QR code, and/or RFID signal of an object which is particularly held by the handling tool. In exemplary embodiments, the handling tool may at least include one of the gripper members and the state-change member. As an example, the handling tool may at least include the form-fit gripper member and the state change member. As another example, the handling tool may at least include at least one friction-fit gripper member and the state change member. As another example, the handling tool may at least include the form-fit gripper member, at least one friction-fit gripper member and the state change member. The clinical lab automation equipped with this exemplary handling tool may efficiently open a refrigerator or tray as an exemplary third object, grab a bottle, a sample rack, a tube, a sample tube, a reagent pack, a reagent bottle, a substrator bottle, or another object, as an exemplary first and/or second object with the at least one gripper member, and upon grabbing the respective object, before transporting the grabbed object to a different location, close the refrigerator or tray again with the state-change member while still holding the first object and/or second object. Thus, grabbing an object and changing the state of an object in a clinical lab environment during a single operation step may be efficiently performed, wherein an object is reliably grabbed and wherein subsequent tasks may be performed in time and energy efficient manner. Since opening times of trays and particularly refrigerators, as well as reaction times of samples and/or reagents in specific temperature and/or humidity sensitive environment may be crucial for clinical experiments, the handling tool accordingly allows for efficiently performing reliable tasks in the clinical lab environment. Furthermore, the handling tool advantageously increases repeatability of particular tasks of a test and/or an experiment, which in turn particularly increases the quality of such tests and/or experiments.

In further exemplary embodiments, the handling tool may at least include one of the gripper members and the touch screen input member. As an example, the handling tool may at least include the form-fit gripper member and the touch screen input member. As another example, the handling tool may at least include at least one friction-fit gripper member and the touch screen input member. As another example, the handling tool may at least include the form-fit gripper member, at least one friction-fit gripper member and the touch screen input member. The clinical lab automation device equipped with this exemplary handling tool may efficiently confirm a requested task displayed at a touch screen, grab a bottle, a sample rack, a tube, a sample tube, a reagent pack, a reagent bottle, a substrator bottle, or another object, as an exemplary first and/or second object with the at least one gripper member, particularly according to the requested task, and upon grabbing and transporting the respective object to a different location, confirm the different location and/or enter the different location to the touch screen again with the touch screen input member while still holding the first object and/or second object. Thus, grabbing and dislocating an object according to a specific task and particularly protocolling thereof in a clinical lab environment may be efficiently performed, wherein an object is reliably grabbed and dislocated, and wherein subsequent tasks may be performed in reliable and time efficient manner. Since reaction times of samples and/or reagents in specific temperature and/or humidity sensitive environment may be crucial for clinical experiments, as well as the protocolling of the respective tasks, in order to provide for a reliable evaluation, the handling tool accordingly allows for efficiently performing reliable tasks in the clinical lab environment. Furthermore, the handling tool advantageously increases repeatability of particular tasks of a test and/or an experiment, which in turn particularly increases the quality of such tests and/or experiments.

In further exemplary embodiments, the handling tool may at least include the form-fit gripper member and the at least one friction-fit gripper member. This particularly allows for form-fittingly or friction-fittingly grabbing an object, such as a bottle or a tube, and transporting, particularly putting the grabbed object at or into another object, such as a bottle holder or sample rack, and further allows for subsequently grabbing the another object for transporting the another object e.g. to a different location. Thus, grabbing and dislocating an object with respect to another object, and subsequentially grabbing and dislocating the another object in a clinical lab environment may be efficiently performed, wherein different objects are reliably grabbed and wherein subsequent tasks may be performed in time efficient manner. Since reaction times of samples and/or reagents in specific temperature and/or humidity sensitive environment may be crucial for clinical experiments, the handling tool accordingly allows for efficiently performing reliable tasks in the clinical lab environment.

In further exemplary embodiments, the handling tool may at least include the touch screen input member and the state-change member, which in accordance with the exemplary embodiments as described above particularly allow for changing the state of an object, such as a refrigerator or tray, for example in accordance with a task displayed on a touch screen and confirming and/or protocolling the performed tasks. Thus, the handling tool allows for efficiently performing reliable tasks in the clinical lab environment.

Even though the objects to be engaged and held by the respective gripper members and the objects to be state-changed by the state-change member may be denoted as first, second and third objects herein, it shall not be excluded that a first object particularly engageable and holdable by the form-fit gripper member may be engageable and holdable by the friction-fit gripper member, and/or may be state-changeable by the state-change member. The same applies for the second and third object, accordingly. In other words, the first object may be different from the second object and may be different from the third object. The second object may be different from the third object. As an alternative, the first object, the second object and the third object may be identical objects and the form-fit gripper member may grip an element of the object different from the element of the same object that the friction-fit gripper member grips and/or different from the element of the same object that the state-change member changes the state thereof.

In particular embodiments of the handling tool, the handling tool may include the form-fit gripper member and the at least one friction-fit gripper member, wherein the form-fit gripper member and the at least one friction-fit gripper member protrude from a base of the handling tool in step-wise manner.

The step-wise manner particularly includes a distance in a first direction and a distance in a second direction, which is substantially perpendicular to the first direction. In particular, the first and the second distance may respectively be substantially perpendicular to a direction in which gripping elements of the at least one friction-fit gripper member and the form-fit gripper member are movable or displaceable relative to one another.

Thus, in other words, the form-fit gripper member may particularly protrude from the base of the handling tool with a distance with respect to the at least one friction-fit gripper member, such that the form-fit gripper member and the at least one friction-fit gripper member protrude from the base of the handling tool in step-wise manner when viewed in a direction, in which gripping elements of the respective grippers are moved or displaced relative to one another for engaging and holding an object. The distance particularly includes a first distance in a first direction and a second distance in a second direction, wherein the second direction is substantially perpendicular to the first direction, and wherein the first direction and the second direction are substantially perpendicular to the direction in which the gripping elements of the respective grippers are moved or displaced relative to one another for engaging and holding the object.

Accordingly, the form-fit-gripper member and the at least one friction-fit gripper member may particularly protrude from the base of the handling tool so as to have a step-wise shape when viewed in a direction in which gripping elements of the respective grippers move relative to one another for engaging and holding an object.

Due to the step-wise shape or step-wise manner, the one of the form-fit gripper member and the at least one friction-fit gripper member is less prone to or does not interfere with an object to be held by the other one of the form-fit gripper member and the at least one friction-fit gripper member. Thus, the handling tool provides for efficiently arranging a plurality of gripper members suitable for performing different tasks in a clinical lab.

In case one of the form-fit gripper member and the at least one friction-fit gripper member includes a plurality of gripper members of a form-fit gripper member type or a friction-fit gripper member type, such gripper members may respectively arranged in line with the above given explanations, i.e. protrude from the base in step-wise manner. In other words, in one example the handling tool comprises a group of gripper members with more than one form-fit gripper members and/or more than one friction-fit gripper members.

Specifically, a form-fit gripper member of a plurality form-fit gripper members may protrude from the base of the handling tool in step-wise manner with respect to adjacently protruding other ones of the plurality of form-fit gripper members and/or with respect to adjacently protruding one or more friction-fit gripper members. Accordingly, a friction-fit gripper member of a plurality friction-fit gripper members may protrude from the base of the handling tool in step-wise manner with respect to adjacently protruding other ones of the plurality of friction-fit gripper members and/or with respect to adjacently protruding one or more form-fit gripper members.

In particular embodiments the handling tool may include
a first friction-fit gripper member for frictionally engaging and holding the second object at substantially parallel side wall portions; and/or
a second friction-fit gripper member for frictionally engaging and holding the second object at substantially curved side wall portions; and/or
a third friction-fit gripper member for frictionally engaging and holding the second object at substantially flat inclined side wall portions.

The second object to be engaged and held by one of the first, second or third friction fit gripper member may be the same object or a different object to be held by the others of the first, second and third friction fit gripper member.

For frictionally engaging and holding the second object at substantially parallel, curved and/or inclined side wall portions, the friction-fit gripper member may have corresponding jaws or gripping elements, or portions of jaws or gripping elements, corresponding to substantially parallel, curved and/or inclined side wall portions of the second object.

Due to the different geometries which are frictionally engageable and holdable by the at least one friction-fit gripper member, a plurality of different objects may securely be engaged and held in efficient and particularly subsequent time-efficient manner by the handling tool.

In particular embodiments of the handling tool, the handling tool may include two or more of the first, second and third friction-fit gripper members,
wherein an upper face of one of the first, second and third friction-fit gripper members and a lower face of another of the first, second and third friction-fit gripper members form a further gripper member for engaging with a further object.

In particular embodiments of the handling tool, the handling tool may include two or more of each of the first, second and third friction-fit gripper members,

The further gripper member(s) may be configured to loosely engage with the further object, in case the friction-fit gripper members being the further gripper member(s) are non-movably attached to the base of the handling tool with respect to one another. Optionally, the further gripper member(s) may frictionally engage with the further object, in case the friction-fit gripper members which form the further gripper member(s) are movably attached to the base of the handling tool with respect to one another, such that a frictional engagement may be adjusted by moving one of the friction-fit gripper members with respect to the other one of the friction-fit gripper members which collectively form the further gripper member(s) for engaging with a further object.

While the friction-fit gripper member(s) and the form-fit gripper member(s) as described herein may be configured to solely engage and hold an object, one or more of the friction-fit gripper members and/or one or more the form-fit gripper members may also be configured to collectively and particularly simultaneously engage and hold an object.

Due to the friction-fit gripper member(s) and/or the form fit-gripper member(s) which may collectively engage and/or hold an object, particularly by forming a further gripper member for gripping and holding a further object with another one of a friction-fit gripper member and/or a form-fit gripper member, the handling tool provides for an efficient functional integration and for efficiently increasing the variety of tasks reliably performable by the handling tool.

In particular embodiments of the handling tool, the touch screen input member may comprise a resilient and/or conductive touching tip and/or a capacitively detectable tip at its distal end,
wherein the touch screen input member optionally is slidably disposed in one of the form-fit gripper member, the at least one friction-fit gripper member and the state-change member.

The touch screen input member having a resilient tip particularly allows to reduce wear in the clinical lab when entering or inputting information into a communication device, particularly into a touch screen. On the other hand, the resilient tip particularly allows for defining a predetermined input force, when entering or inputting information into the communication device, particularly into the touch screen, by adjusting the compressed distance of the resilient tip when entering or inputting the information.

Accordingly, the resilient tip particularly provides for a reliable and secure means for entering and inputting information, while particularly reducing the chance or even preventing unintended information input, due to accidently touching the touch screen.

The conductive touching tip particularly allows for conductively detecting a touch of the touching tip, and thus particularly allows for distinguishing between a non-conductive touch action and a conductive touch action of the touch screen, wherein a non-conductive touch action may for example be caused by touching, particularly unintended touching, of the display with the gripper members or the state-change member.

Thus, due to the conductive touching tip, the input security may be efficiently enhanced.

The capacitively detectable tip particularly allows to reduce wear in the clinical lab when entering or inputting information into a communication device, particularly into a touch screen, since information may be entered or input without direct contact, i.e. without direct touch, between the touch-screen input member and the touch screen.

Thus, due to the capacitively detectable tip, the input security may be efficiently enhanced, and a clean clinical lab environment may be efficiently maintained.

By at least partially disposing the touch screen input member in one of the form-fit gripper member, the at least one friction-fit gripper member and the state-change member, the touch screen input member may be efficiently stored. Furthermore, by slidably disposing the touch screen input member in one of the form-fit gripper member, the at least one friction-fit gripper member and the state-change member, particularly by adjustably slidably disposing the touch screen input member therein, entering or inputting information into the touch screen may advantageously be enhanced, wherein a risk of unintended input or unintended touch of the touch screen by other than the touch screen input member may advantageously be reduced or even prevented. Specifically due to the adjustable length by which the touch screen input member protrudes from one of the form-fit gripper member, the at least one friction-fit gripper member and the state-change member, a touching force for touching the touch display may advantageously be adjusted, for example according to a required force when entering or inputting information, particularly for entering or inputting crucial information, such as alerts with respect to one or more experiments, or alerts with respect to the clinical lab environment, for example concerning temperature, humidity, toxicity for a human, toxicity for a sample, etc.

In particular embodiments of the handling tool, the state-change member may include an engagement finger, particularly a pair of engagement fingers, for example a pair of opposing or parallel engagement fingers,
wherein the state-change member is configured to change an open state of the third object to a closed state of the third object, or for changing the closed state of the third object to the open state of the third object, and
wherein the state-change member optionally protrudes from one of the form-fit gripper member and the at least one friction-fit gripper member.

The state-change member, particularly due to its engagement finger(s), advantageously allows for precisely changing the state of the third object, which may for example be a refrigerator, a tray, an oven, a light switch, a camera, a chemical sensor, a physical sensor, and/or a microscope etc. The state to be changed may accordingly be an open or a closed refrigerator and/or tray, a temperature of a refrigerator and/or an oven, particularly adjustable by a turning wheel and/or a button, such as a warmer/colder button. Additionally or alternatively, the state to be changed may be a light to be switched on or off, and/or a camera, a sensor and/or a microscope to be turned on or off, and/or a wavelength, a resolution and/or a sensitivity of a light switch, a camera, a sensor and/or a microscope to be adjusted, etc.

In particular embodiments, the state-change member, and particularly its engagement finger(s) may be integrally formed with one of the form-fit gripper member and the at least one friction-fit gripper member. That is, the engagement finger(s) of the state-change member may for example protrude from or be the gripping element(s) of the form-fit gripper member or one of the friction-fit gripper members. Thus, the versatility of the handling tool for performing various different tasks can be efficiently improved.

In particular embodiments of the handling tool, the at least one friction-fit gripper member may have a pad including rubber and/or foamed rubber at a side which faces the object to be engaged. In particular embodiments of the handling tool, all of the friction-fit gripper members may have a pad including rubber and/or foamed rubber at a side which faces the object to be engaged.

In other words, one of the first, second and third friction-fit gripper members or two of the first, second and third friction-fit gripper members or all of the first, second and third friction-fit gripper members may have a pad including rubber and/or foamed rubber and/or an elastomer and/or plastic at a side which faces the object to be engaged.

Due to the rubber and/or foamed rubber at a side for engaging the object, damage to the object may efficiently be prevented, the friction coefficient, and consequently the frictional force, can efficiently be increased, particularly without requiring an increased pressing force/normal force to be applied by the respective friction-fit gripper member, as well as wear of the object can efficiently be decreased or prevented.

Thus, due to rubber and/or foamed rubber side of the friction-fit gripper, reliably and securely engaging and holding of an object can be enhanced, while advantageously reducing the risk of damage to the object, as well as advantageously reducing the risk of contaminating the clinical lab environment.

In particular embodiments of the handling tool, the form-fit gripper member may be configured to engage the first object along a displacement direction of the form-fit gripper member, and to provide a form-fit with the first object in a direction substantially perpendicular to the displacement direction of the form-fit gripper member,
particularly while allowing a rotation of the first object about the direction in which the form-fit gripper member provides the form-fit in an engaged state of the form-fit gripper member.

Thus, the form-fit gripper member may advantageously engage the first object at a comparatively small or narrow portion, particularly at a tapered portion, such as a neck of the first object, for example from opposing sides in the displacement direction. The first object may advantageously be held perpendicular to the displacement direction in form-fit manner, for example, up and down in form-fit manner, or downward in form-fit manner and upward due to gravity force. Thus, the form-fit gripper member allows for easily engaging and holding the first object, such as a bottle and/or a tube, particularly a sample tube, while further allowing to securely transport the first object to a different location, and dispose the first object at the different location, such as a sample rack, a bottle rack, a bottle box, and/or a refrigerator.

In particular embodiments of the handling tool, the form-fit gripper member may include a first pair of opposing gripping elements, wherein each gripping element of the first pair of opposing gripping elements has a substantially semi-circular recess at a side facing the other gripping element of the first pair of opposing gripping elements, wherein the gripping elements of the first pair of opposing gripping elements are displaceable relative to one another.

The gripping elements of the first pair of opposing gripping element may particularly be displaceable relative to one another so as to form an adjustable substantially circular gap in between the first gripping elements, in order to form-fittingly engage a small or narrow portion, particularly a tapered portion of the first object, such as a neck of the first object. The third object, without being limited thereto, may have a substantially circular small or narrow, particularly tapered portion, such as a neck, but may also have a polygonal small or narrow, particularly tapered portion, in a cross-section in which the opposing gripping elements have the substantially semi-circular recess.

Thus, a plurality of differently objects may be securely and efficiently engaged with and held by the form-fit gripper member of the handling tool.

In particular embodiments of the handling tool, the first friction-fit gripper member may include a second pair of opposing gripping elements, wherein the gripping elements of the second pair of opposing gripping elements have substantially parallel faces facing each other.

Owing to the substantially parallel faces of the second pair of gripping elements, the friction-fit gripper member can efficiently and securely engage and hold the second object which at least partially has two opposed substantially parallel or only slightly curved side walls.

In particular embodiments of the handling tool, the second friction-fit gripper member may include a third pair of opposing gripping elements, wherein the gripping elements of the third pair of opposing gripping elements are curved, so as to at least partially surround the second object in an engaged state of the second friction-fit gripper member.

Due to the curved third pair of gripping elements, the friction-fit gripper member can efficiently and securely engage and hold the second object which at least partially has a curved side wall or curved side walls.

In particular embodiments of the handling tool, the third friction-fit gripper member may include a fourth pair of opposing gripping elements, wherein the gripping elements of the fourth pair of opposing gripping elements are inclined, such that a distance between the opposing gripping elements of the fourth pair of opposing gripping elements increases toward a tip of the gripping elements.

Due to the inclined fourth pair of gripping element, the friction-fit gripper member can efficiently and securely engage and hold the second object which at least partially has inclined side walls.

In particular embodiments of the handling tool, the handling tool may include two or more gripper members, wherein the two or more gripper members, particularly each of the two or more gripper members, are displaceable in the substantially same direction. In other words, the handling tool may include two or more of
a form-fit gripper member for form-fit engaging and holding an object, particularly referred to as a first object and
at least one friction-fit gripper member for frictionally engaging and holding an object, particularly referred to as a second object, wherein the two or more of the form-fit gripper member and the at least one friction-fit gripper member, particularly each of them, are displaceable in substantially the same direction.

This advantageously allows to provide the handling tool with a one direction displacement actuation, and thus allows to efficiently simplify the handling tool.

In exemplary embodiments, the two or more gripper members, i.e. the two or more of the form-fit gripper member and the at least one friction-fit gripper member, may be attached to the same base of the handling tool. The base of the handling tool may for example include opposing base elements, wherein one gripping element of a pair of gripping elements is attached to a first base element, and the other gripping element of a respective pair of gripping elements is attached to a second base element. The first and second base elements may particularly be displaceable with respect to one another, particular in the displacement direction, for example by an actuator, such as a one direction displacement actuation.

The one direction displacement actuation may for example be configured to move the one gripping element of the pair of gripping elements relative to the other gripping element of the respective pair of gripping elements in the displacement direction. The displacement direction may particularly be a direction in which, when being displaced, the gripping members are configured to engage the respective objects and apply a pressing force, resulting for example in a friction-fit and/or form-fit. Optionally, the one direction displacement actuation may be configured to move both of the one gripping element of the pair of gripping elements and the other gripping element of the respective pair of gripping elements relative to one another in the displacement direction, for example simultaneously toward one another, i.e. by reducing the distance in the displacement direction, or apart one another, i.e. by increasing the distance in the displacement direction.

In particular embodiments of the handling tool, the handling tool may include two or more gripper members, wherein the two or more gripper members, particularly each of the two or more gripper members, are displaceably actuated by the same actuator. This advantageously allows to further provide the handling tool with an efficient and simplified displacement actuation, and thus allows to further efficiently simplify the handling tool.

In exemplary embodiments, the two or more gripper members may be attached to the first and second base elements, which may respectively be displaceable with respect to one another by the same actuator, such as a single one direction displacement actuation. The single one direction displacement actuation may particularly be configured to simultaneously displace both gripping elements of the respective pairs of gripping elements of the respective form-fit gripping members and/or friction-fit gripping members. Thus, simultaneous displacement of the respective gripping elements may efficiently be provided, and the number of parts may efficiently be reduced, while still providing for increased functionality of performing different tasks with the handling device.

According to another aspect of the present invention, a clinical lab automation device is provided, the clinical lab automation device comprising:
a robot arm having a plurality of robot arm segments, wherein the robot arm segments are connected to one another via joints;
a handling tool as described above, wherein the handling tool is connected to the distal robot arm segment of the robot arm.

In particular embodiments of the clinical lab automation device, the clinical lab automation device may further comprise:
a camera for monitoring the handling tool, wherein the camera is independently movable relative to the handling tool.

In particular embodiments, movement of the camera, particularly rotational movement of the camera, may be independent from displacement of the gripper members, of the touch-screen input member and/or of the state-change member.

The camera which may be independently movable relative to the handling tool may advantageously provide for an adjustable focus, field of view, and/or point of view, particularly adjustable based on the task to be performed by the respective member (i.e. respective form-fit gripper member, friction-fit gripper member, touch screen input member, and/or state-change member) of the handling tool.

The camera particularly being independent from displacements of the gripper members, of the touch-screen input member and/or of the state-change member further particularly allows maintaining or adjusting a field of view and/or a point of view without being affected by the displacement of the gripper members, of the touch-screen input member and/or of the state-change member.

In particular embodiments, the camera may be rotatable about the distal robot arm segment. In exemplary embodiments, the camera may be disposed at or attached to the distal robot arm segment.

The camera being disposed at or attached to the distal arm segment advantageously allows for making the field of view of the camera passively following the handling tool, when the clinical lab automation device performs a task with the handling tool, which is connected to the distal arm segment.

Furthermore, the camera being rotatable about the distal robot arm segment advantageously allows for adjusting the field of view and/or the point of view of the camera, while maintaining a fix point with respect to the handling tool in different rotational positions about the distal robot arm segment, particularly based on the rotational axis provided by the distal robot arm segment, about which the camera may rotate. The camera being rotatable and particularly being disposed to or attached at the distal robot arm segment advantageously enhances the geometrical recognition of an object or touch screen to be processed by the handling tool, thus efficiently increasing the handling tool's reliability when performing tasks.

In particular embodiments of the clinical lab automation device, the clinical lab automation device may be configured to hold at least one object with at least one of the form-fit gripper member and the at least one friction-fit gripper member,
while inputting information to a touch screen via the touch screen input member, and/or while changing a state of the third object via the state-change member.

The clinical lab automation device thus advantageously allows to time-efficiently and/or energetic-efficiently perform particular subsequent tasks on different objects in a lab environment.

Particular, exemplary and alternative embodiments of the aspect relating to the handling tool for a clinical lab automation device and their effects accordingly apply to the aspect relating to the clinical lab automation device and its particular, exemplary and alternative embodiments, and vice versa.

These and other objects, features and advantages of the present invention will become more apparent upon reading of the following detailed description of particular embodiments and accompanying drawings. It should be understood that even though embodiments are separately described, single features thereof may be combined to additional embodiments.

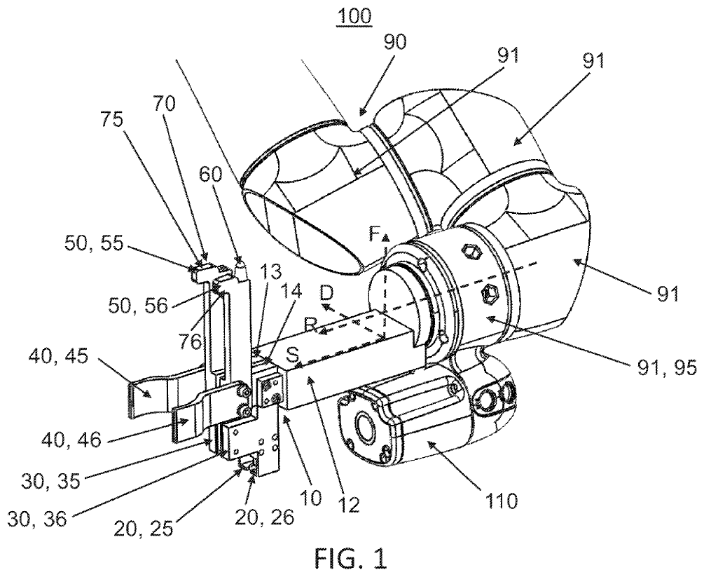

FIG. 1 shows an exemplary handling tool attached to a clinical lab automation device;

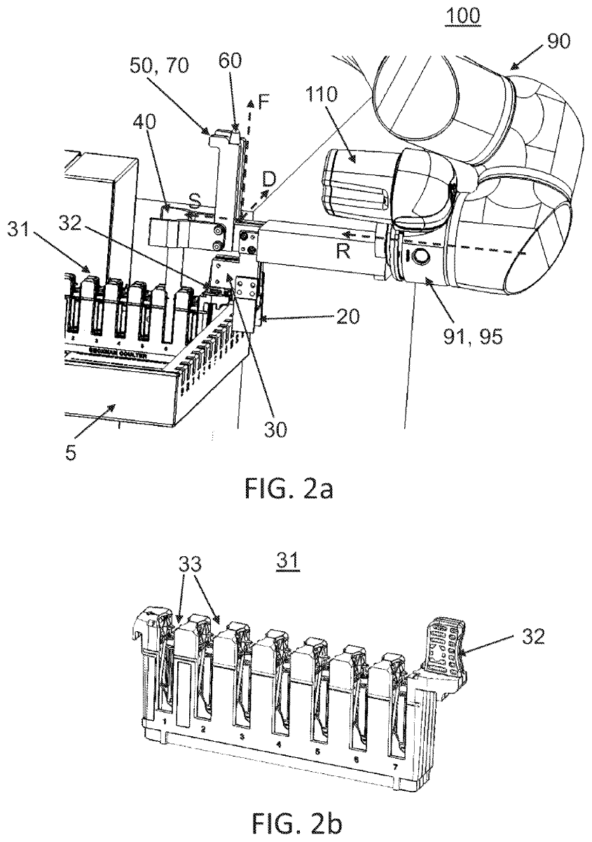

FIG. 2a shows an exemplary handling tool attached to a clinical lab automation device, when handling a sample rack as an exemplary object via a friction-fit gripper member;

FIG. 2b shows a sample rack as an exemplary object engageable and holdable by a handling tool;

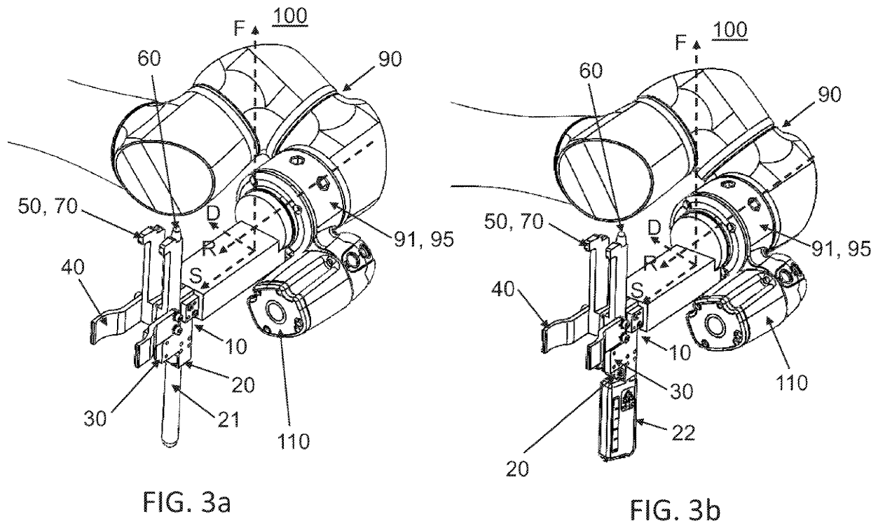

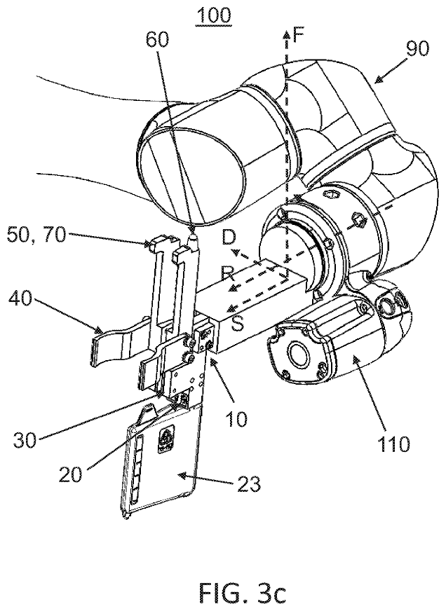

FIGS. 3a, 3b, 3c show an exemplary handling tool attached to a clinical lab automation device, when handling different exemplary objects via a form-fit gripper member;

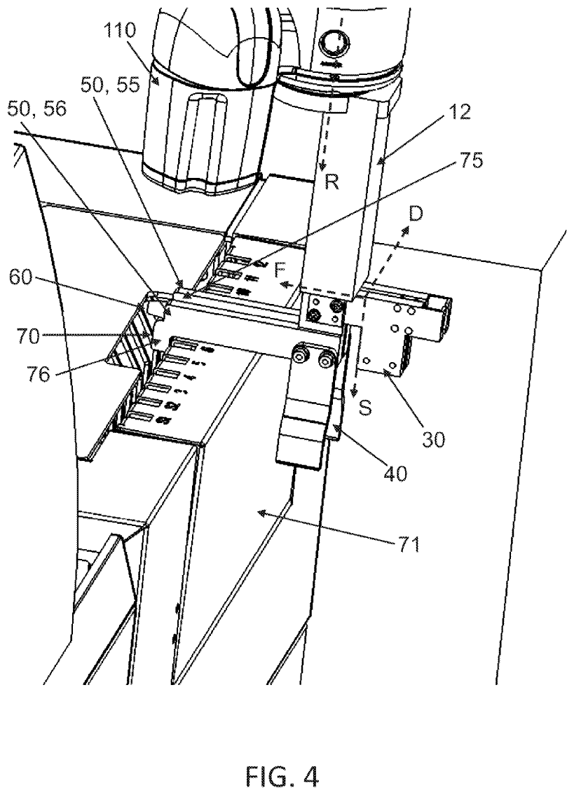

FIG. 4 shows an exemplary handling tool, when handling an exemplary object in order to change its state via a state-change member;

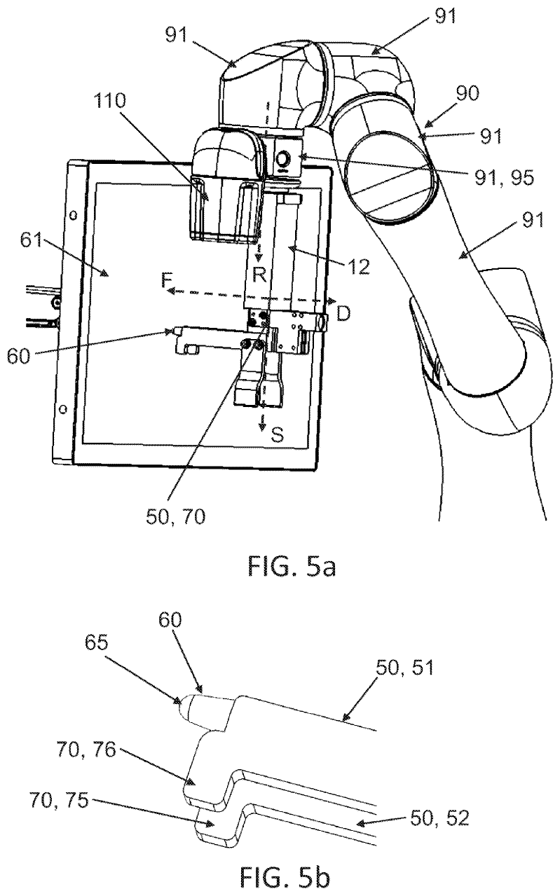

FIG. 5a shows an exemplary handling tool attached to a clinical lab automation device, when inputting information into a touch screen via a touch screen input member;

FIG. 5b shows an exemplary touch screen input member at least partially disposed in another member of a handling tool;

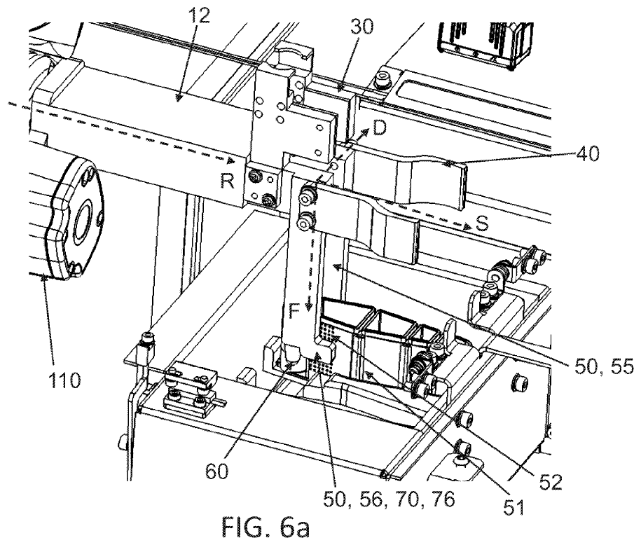

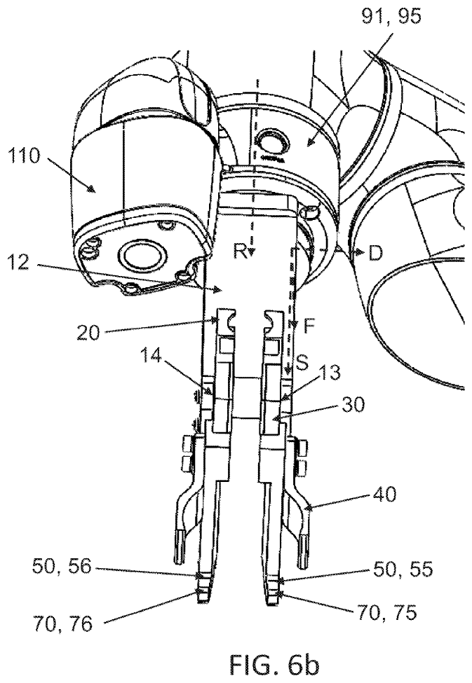

FIG. 6a shows an exemplary handling tool attached to a clinical lab automation device, when handling an exemplary object via a friction-fit gripper member;

FIG. 6b shows a portion of an exemplary handling tool; and

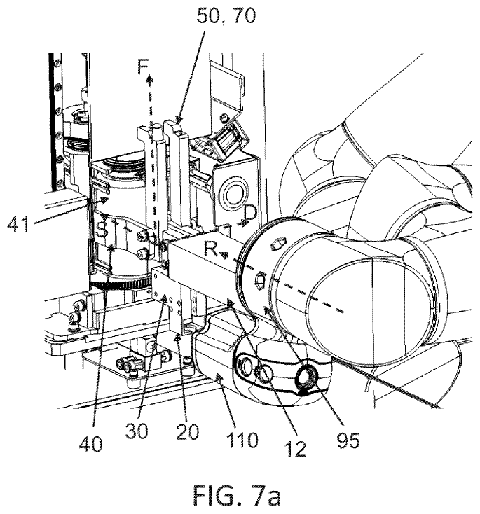

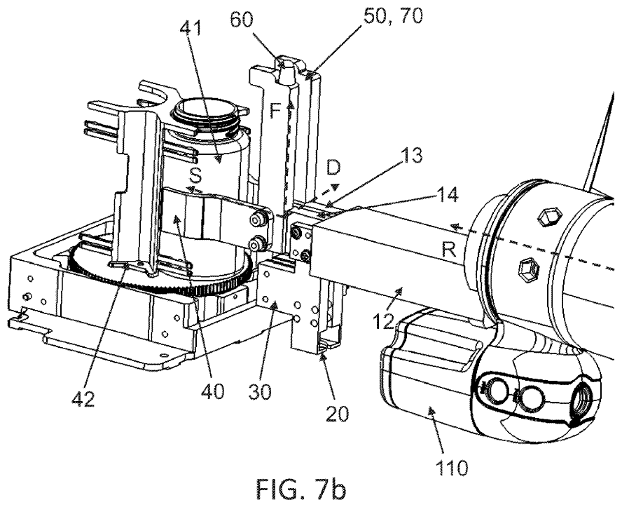

FIGS. 7a, 7b show. an exemplary handling tool attached to a clinical lab automation device, when handling a bottle as an exemplary object via a friction-fit gripper member.

FIG. 1 shows an exemplary handling tool 10 attached to a clinical lab automation device 100, which particularly includes a robot arm 90 with a plurality of robot arm segments 91. The handling tool 10 is attached to the distal robot arm segment 95 by the base 12 of the handling tool 10.

As shown in FIG. 1, the base 12 of the handling tool 10 may particularly be rotatably attached to the distal robot arm segment 95, such that the handling tool 10 is rotatable about the rotational axis R. Furthermore, the handling tool 10 is movable by the robot arm 90 and its robot arm segments 91, which are rotatably joined with respect to one another, such that the clinical lab automation device 100 is configured to move the handling tool 10 as required in the three-dimensional space.

Furthermore, as shown in FIG. 1, as well as in FIGS. 2a, 3a, 3b, 3c, 4, 5a, 6a and 7a, the clinical lab automation device 100 may particularly include at least one camera 110 which is attached to the distal robot arm segment 95. Said at least one camera 110 may be rotatably attached to the distal robot arm segment 95, for example by rotating about the rotational axis R, for example around the distal robot arm segment 95.

A first base element 13 and a second base element 14 may be mounted to the base 12 of the handling tool 12, wherein the first base element 13 and the second base element 14 are displaceably mounted to the handling tool 12, respectively. The first base element 13 and the second base element 14 may be independently displaceable with respect to one another.

In particular embodiments however, the first base element 13 and the second base element 14 may be displaceable with respect to one another substantially in the displacement direction D, particularly exclusively displaceable with respect to one another substantially in the displacement direction D. Therefore, the first and second base element 13, 14 may for example be connected to one single displacement actuation, which may for example be housed in the base 12, as shown in FIG. 1 and which may be actuatable on the basis of a command issued by the clinical lab automation device 100. The first and second base element 13, 14 may accordingly be simultaneously displaceable with respect to one another substantially in the displacement direction D.

As illustrated in FIG. 1, by displacement in the displacement direction D, the handling tool 10 may be configured to respectively open and close at least some of the gripper members 20, 30, 40, 50. The gripper members 20, 30, 40, 50 are particularly connected to the base 12, for example intermediary connected to the base 12, via the first and second base elements 13, 14. Thus, the gripper members 20, 30, 40, 50 may particularly be displaceable in accordance with a respective displacement of the first and second base elements 13, 14.

As shown in FIG. 1, as well as in FIGS. 2a, 3a, 3b, 3c, 4, 5a, 6a, 6b, 7a and 7b, the gripper members 20, 30, 40, 50 protrude from the base 12 in step-wise manner. Thus, the gripper members 20, 30, 40, 50, and particularly their object gripping portions may particularly be spaced from one another substantially in a first direction F and substantially in a second direction S. The first and second direction F, S are substantially perpendicular to one another. Furthermore, the first and second direction F, S are substantially perpendicular to the displacement direction D. Thus, different objects may advantageously be grabbed by one of the gripping members 20, 30, 40, 50 without interference with another one of the gripping members 20, 30, 40, 50.

As shown in FIG. 1, and as further shown in FIG. 2a, the handling tool 10 may particularly comprise a first friction-fit gripper member 30, wherein the first friction-fit gripper member 30 is particularly configured to grab an object having substantially parallel side walls facing the gripping elements 35, 36 of a pair of gripping elements 35, 36 of the first friction-fit gripper member 30.

Therefore, the gripping elements 35, 36 of the first friction-fit gripper member may particularly have substantially parallel faces facing each other in the displacement direction D, for engaging and holding an object.

FIG. 2a shows an exemplary handling tool 10 attached to a lab automation device 100, when handling a sample rack 31 as an exemplary object via a friction-fit gripper member 30. FIG. 2b shows a sample rack 31 as an exemplary object engageable and holdable by a handling tool 10. The handling tool 10 and/or the clinical lab automation device 100 as shown in FIG. 2a may particularly correspond to the one as shown in FIG. 1.

As shown in FIGS. 2a and 2b, a sample rack 31 may be an exemplary object to be engaged and held by the first friction-fit gripper member 30. The sample rack 31 may particularly include a holding portion 32 having substantially parallel opposing side faces, which may be substantially perpendicular to the displacement direction D, and which are to be engaged and held by the first friction-fit gripper member 30. The sample rack 31 includes one or more sample slots 33, at which a tube or sample tube 21, as exemplarily shown in FIG. 3a, may be disposed, in order to conduct an experiment or to carry a plurality of sample tubes 21 to a particular location, so that the sample tubes 21 underly the same or substantially same environmental conditions in a clinical lab.

As shown in FIG. 2a, and particularly owing to the step-wise protruding gripper members 20, 30, 40, 50, the sample rack 31, exemplarily located in a storage 5, may be reliably engaged and held by the first friction-fit gripper member 30. The thus grabbed sample rack 31, may then be transported to a different place, such as a refrigerator, a sensor arrangement or something else, as for example requested and/or prompted to the clinical lab automation device 100 via a touch screen 61 as shown in FIG. 5a.

Before engaging the sample rack 31, the clinical lab automation device 100 may be configured to localize the sample rack 31 via the camera 110. The camera 110 is particularly rotatable about the distal robot arm segment 95, at which the handling tool 10 is attached. However, since both of the camera 110 and the handling tool 10 are attached to the distal robot arm segment 95, the camera 110 is advantageously translationally moved in accordance with the handling tool 10 by the clinical lab automation device 100, such that localization and focusing of the sample rack 31 is enhanced.

As an exemplary task to be performed by the clinical lab automation device 100, the clinical lab automation device 100 may first of all be requested via the touch screen 61 to pick up, or engage and hold the sample rack 31 located in the storage 5. The clinical lab automation device 100 may recognize the request visually, for example via the camera 110, or by wire or wirelessly in a control unit of the clinical lab automation device 100. The clinical lab automation device 100 may then, in particular, confirm said request, decline said request or indicate an error in the request, for example in that the request is not understood by the lab automation device 100, via the touch screen input member 60 to the touch screen 61.

The lab automation device 100 may be configured to localize and focus the sample rack 31 in the storage 5 particularly via the camera 110, for example by rotating the camera 110 about the rotational axis R in order to efficiently capture the sample rack 31 from different point of views. The sample rack 31 may for example be approached by the handling tool 10, in that predetermined stop-positions at which a lateral distance are maintained with respect to the sample rack 31, as an exemplary object, but at which the camera 110 is rotated for capturing the sample rack 31 from different point of views.

When reaching a target position of the handling tool 10 relative to the sample rack 31, the handling tool 10 is configured to move the gripping elements 35, 36 substantially in the displacement direction D so as to reduce the distance between the opposing gripping elements 35, 36, in order to frictionally engage the sample rack 31, and particularly the holding portion 32 of the sample rack 31.

Upon picking up, or upon engaging and holding the sample rack 31 from the storage 31, the clinical lab automation device 100 may confirm the completion of the task again via the touch screen input member 60 of the handling tool 10, while holding the sample rack 31 with the first friction-fit gripper member 30 of the handling tool 10, in order to receive a subsequent task, to be particularly requested via the touch screen 61.

Accordingly, the handling tool 10 of the clinical lab automation device 100 particularly allows for efficiently performing subsequent tasks in a clinical lab environment, while particularly allowing efficient protocolling of the tasks as performed by the clinical lab automation device 100, thus particularly enhancing repeatability of experiments and tests as conducted in the clinical lab environment.

FIGS. 3a, 3b and 3c show an exemplary handling tool 10 attached to a lab automation device 100, when handling different exemplary objects via a form-fit gripper member 20. The handling tool 10 and/or the clinical lab automation device 100 as shown in FIGS. 3a, 3b and 3c may particularly correspond to the one as shown in FIGS. 1 and 2a.

As shown in FIGS. 1, 3a, 3b and 3c, a sample tube 21 or a cartridge 22, 23, such as a sample or reagent cartridge, may be an exemplary object to be engaged and held by the form-fit gripper member 20. The sample tube 21 and/or cartridge 22, 23 may particularly include a neck, having a comparatively reduced cross-section or diameter compared to a portion above the neck in the first direction F. The sample tube 21 and/or the cartridge 22, 23 may for example be disposable in the sample rack 31, and/or in a cartridge rack, in order to conduct an experiment or to carry a plurality of sample tubes 21 and/or cartridges 22, 23 to a particular location, so that the sample tubes 21 and/or cartridges 22, 23 underly the same or substantially same environmental conditions in a clinical lab.

As shown in FIGS. 1, 3a, 3b and 3c, and particularly owing to the step-wise protruding gripper members 20, 30, 40, 50, the sample tube 21 or a cartridge 22, 23, which may for example be disposed in a rack such as sample rack 31 as shown in FIGS. 2a and 2b, may be reliably engaged and held by the form-fit gripper member 20. The thus grabbed sample tube 21 or a cartridge 22, 23 may then be transported to a different place, such as a refrigerator, a sensor arrangement, another rack or something else, as for example requested and/or prompted to the clinical lab automation device 100 via a touch screen 61 as shown in FIG. 5a.

Before engaging the sample tube 21 or a cartridge 22, 23, the clinical lab automation device 100 may be configured to localize the sample tube 21 or a cartridge 22, 23 via the camera 110. As emphasized with respect to FIGS. 1 and 2a, the camera 110 is particularly rotatable about the distal robot arm segment 95, such that for further explanations and effects, it is referred to FIGS. 1 and 2a.

For an exemplary task to be performed by the clinical lab automation device 100, it is referred to explanations and effects as emphasized with respect to FIGS. 1 and 2a, wherein with regards to FIGS. 3a, 3b and 3b, the sample tube 21 and the cartridge 22, 23 is to be replace with the sample rack 31.

As shown in FIGS. 1, 3a, 3b and 3c, the form-fit gripper member 20 may particularly include gripping elements 25, 26 for engaging and holding an object, such as the sample tube 21 and the cartridge 22, 23. Therefore, the gripping elements 25, 26 of the form-fit gripper member 20 are particularly opposingly arranged at the handling tool 10, particularly with respect to the displacement direction D. Furthermore, the gripping elements 25, 26 may particularly have a recess, such as a curved or a semi-circular recess, at sides of the gripping elements 25, 26 which face one another. When viewed in the first direction F, the gripping elements 25, 26 may accordingly define a hole or portions of a circle, at which the neck of an object, such as the sample tube 21 and the cartridge 22, 23 may be disposed, in order to provide for a form-fit engagement of the form-fit gripping member 20 with respect to said object.

For reliably engaging and holding an object with the form-fit gripper member 20, the object does not require a circular cross-section. Instead, a neck having a comparatively reduced cross-section or diameter, with respect to a portion above the neck in the first direction F, is sufficient for an object to be engaged and held by the form-fit gripper member 20.

When reaching a target position of the handling tool 10 relative to the object, such as the sample tube 21 and the cartridge 22, 23, the handling tool 10 is configured to move the gripping elements 25, 26 substantially in the displacement direction D so as to reduce the distance between the opposing gripping elements 25, 26, in order to reduce the distance between the gripping elements 25, 26 at the neck of the object, such as the sample tube 21 and the cartridge 22, 23, and thus to form-fittingly engage said object, such as the sample tube 21 and the cartridge 22, 23, and particularly to hold said object.

Upon picking up, or upon engaging and holding said object, such as the sample tube 21 and the cartridge 22, 23, the clinical lab automation device 100 may confirm the completion of a particular task again via the touch screen input member 60 of the handling tool 10, while holding said object, such as the sample tube 21 and the cartridge 22, 23, with the form-fit gripper member 20 of the handling tool 10, in order to receive a subsequent task, to be particularly requested via the touch screen 61.

Consequently, the handling tool 10 of the clinical lab automation device 100 particularly allows for efficiently performing a variety of subsequent tasks in a clinical lab environment, while particularly allowing efficient protocolling of the tasks as performed by the clinical lab automation device 100, thus particularly enhancing repeatability of experiments and tests as conducted in the clinical lab environment.

FIG. 4 shows an exemplary handling tool 10, when handling an exemplary object, such as a tray 71, in order to change its state via a state-change member 70. The handling tool 10 and/or the clinical lab automation device 100 as shown in FIG. 4 may particularly correspond to the one as shown in FIGS. 1, 2a, 3a, 3b and 3c.

As shown in FIGS. 1 and 4, a tray 71 may be an exemplary object to be engaged and/or state-changed by the state-change member 70. The tray 75 may for example be used as a tray 75 of a refrigerator, or as a different tray 75 including particular environmental conditions within, for storing samples, sample tubes, and/or reagents at particular environmental conditions, or as a rather simple tray 75 for storage, similar to storage 5 as shown in FIG. 2a.

As shown in FIGS. 1 and 4, and particularly owing to the step-wise protruding gripper members 20, 30, 40, 50, the tray 75 may be reliably engaged by one or more engagement fingers 75, 76 of the state-change member 70, and the state of the tray 75 may reliably changed from closed to opened, or from opened to closed. The thus opened tray 75 may then be entered by the robot arm 90 and particularly by the handling tool 10 attached thereto, in order to dispose an object therein, or to withdraw an object such as a sample tube therefrom, which in both cases may particularly be performed on the basis of the gripper members 20, 30, 40, 50, as emphasized with respect to FIGS. 2a, 3a, 3b, 3c, 6a, 7a and 7b, and particularly in conjunction with tasks to be confirmed and/or declined by the touch screen input member 60, as particularly emphasized with respect to FIGS. 5a and 5b. Thus, it is referred to the respective explanations particularly given with respect to the further FIGS. 1, 2a, 3a, 3b, 3c, 5a, 5b, 6a, 7a and 7b.

Consequently, the handling tool 10 of the clinical lab automation device 100 further allows for efficiently performing a variety of subsequent tasks in a clinical lab environment, while particularly allowing efficient protocolling of the tasks as performed by the clinical lab automation device 100, thus particularly enhancing repeatability of experiments and tests as conducted in the clinical lab environment.

As shown in FIGS. 1, 2a, 3a, 3b, 3c, 4, 5a, 6a, 6b, 7a and 7b, the one or more engagement fingers 75, 76 may particularly correspond to the one or more gripping elements 35, 36, 45, 46, 55, 56 of a friction-fit gripper member 30, 40, 50, such as the one or more gripping elements 55, 56 of the third friction-fit gripper member 50. Thus, the functionality of the handling tool 10 may be efficiently improved.

As particularly shown in FIGS. 1, 2a, 3a, 3b, 3c, 4, 5a, 6a, 6b, 7a and 7b, the engagement fingers 75, 76 are particularly displaceable relative to one another in the displacement direction D, such that a predetermined force and/or force distribution may be applied by the engagement fingers 75, 76 to open or close the tray 71, to open or close the door of a refrigerator, to switch the state of a knob and/or button, to turn a turning wheel, for example for adjusting a temperature state, etc.

FIG. 5a shows an exemplary handling tool 10 attached to a lab automation device 100, when inputting information into a touch screen 61 via a touch screen input member 60. FIG. 5b shows an exemplary touch screen input member 60 at least partially disposed in another member of a handling tool 10. The handling tool 10 and particularly the touch screen input member 60, as shown in FIGS. 5a and 5b may particularly correspond to the ones as shown in FIGS. 1, 2a, 3a, 3b, 3c and 4.

The touch screen input member 60 as shown in FIGS. 5a and 5b may be configured to input information into the touch screen 61 via a contact, for example upon pressing the touch screen input member 60 with the handling tool 10 to the face of the touch screen 61 with a predetermined input force. Additionally or alternatively, the touch screen input member 60 may be configured to input in a contactless manner information into the touch screen 61, for example capacitively, and/or via a visual signal, and/or via near field communication (NFC), wherein a respective signal is actively emitted from the touch screen input member 60 to the touch screen 61, such as a visual signal and/or a NFC signal, or passively emitted from the touch screen input member 60 to the touch screen 61 such as a capacitive signal.

In particular embodiments and as shown in FIGS. 1, 2a, 3a, 3b, 3c, 4, 5a, 5b, 6a, 7a and 7b, the touch screen input member 60 may be at least partially disposed in one of the gripper members 20, 30, 40, 50, such as the third friction-fit gripper member 50. The touch screen input member 60 may be slidably disposed therein, particularly adjustably slidable disposed therein. The length by which the touch screen input member 60 protrudes from the gripper member 20, 30, 40, 50 may for example be adjusted by a spring member, and/or hydraulically, and/or by a pin form-fitted to the touch screen input member 60, and/or by an extendible actuator, and/or other means for adjusting the length by which the touch screen member 60 protrudes from the gripper member 20, 30, 40, 50 inside which it is at least partially disposed.

The tip 65 of the touch screen member 60, as exemplarily shown in FIG. 5b, may be a resilient tip, an at least partially transparent tip, and/or an electrically conductive or isolating tip.

FIG. 6a shows an exemplary handling tool 10 attached to a lab automation device 100, when handling an exemplary object via a third friction-fit gripper member 50. FIG. 6b shows a portion of an exemplary handling tool 10. The handling tool 10 and/or the clinical lab automation device 100 as shown in FIGS. 6a and 6b may particularly correspond to the ones as shown in FIGS. 1, 2a, 3a, 3b, 3c, 4 and 5a.

As shown in FIG. 6a, a container 51, such as a sample container or a reagent container may be an exemplary object to be engaged and held by the third friction-fit gripper member 50. The container 51 may particularly include a holding portion 52 having substantially inclined opposing side faces, which may particularly be inclined so as to reduce a thickness of the container 51 in the thickness direction D along a lengthwise extension of the container 51.

As illustrated in FIGS. 6a and 6b, the opposing faces of the third friction-fit gripper member 50, which may particularly be provided by opposing gripping elements 55, 56 of the third friction-fit gripper member 50, may particularly at least partially have an inclination corresponding to the inclination of the opposing side faces of the container 51.

When grabbing the container 51, the clinical lab automation device 100 may be configured to align the second direction S with the lengthwise extension of the container 51 in order to match the inclinations of the opposing gripping elements 55, 56 with the opposing side faces of the container 51, so as to reliably frictionally engage and hold the container 51 as an exemplary object. In exemplary embodiments, the gripping elements 55, 56 may have opposing side faces which, along adjacent portions of the gripping elements 55, 56 in the second direction S, provide different inclination angles with respect to the second direction S, in order to allow for different inclined side surfaces of various objects to be reliably grabbed.

As shown in FIGS. 1, 6a and 6b, and particularly owing to the step-wise protruding gripper members 20, 30, 40, 50, the container 51 may be reliably engaged and held by the third friction-fit gripper member 50. The thus grabbed container 51 may then be transported to a different place, such as a refrigerator, a sensor arrangement or something else, as for example requested and/or prompted to the clinical lab automation device 100 via the touch screen 61 as shown in FIG. 5a.

For localization via the camera 110, for subsequent tasks with respect to the touch screen 61, as well as for displacement in the displacement direction D with particular regards to the gripping elements 55, 56, it is referred to the explanations given with respect to FIGS. 1 and 2a, along with their effects.

FIGS. 7a and 7b show an exemplary handling tool 10 attached to a lab automation device 100, when handling a bottle 41 as an exemplary object via a second friction-fit gripper member 40. The handling tool 10 and/or the clinical lab automation device 100 as shown in FIGS. 7a and 7b may particularly correspond to the ones as shown in FIGS. 1, 2a, 3a, 3b, 3c, 4, 5a, 6a and 6b.

As shown in FIGS. 7a and 7b, a bottle 41, such as a sample bottle or a reagent bottle may be an exemplary object to be engaged and held by the second friction-fit gripper member 40. The bottle 41 may particularly be provided to or the be placed at a bottle conveyor 42. The bottle 41 may have a substantially side wall, which may particularly be substantially circular in a cross-section substantially perpendicular to the first direction F.

As illustrated in FIGS. 7a and 7b, the opposing faces of the second friction-fit gripper member 40, which may particularly be provided by opposing gripping elements 45, 46 of the second friction-fit gripper member 40, may particularly at least partially have a curved shape, so as to at least partially form a substantially circular hole in a cross-section substantially perpendicular to the first direction.

As shown in FIGS. 1, 7a and 7b, and particularly owing to the step-wise protruding gripper members 20, 30, 40, 50, the bottle 41 may be reliably engaged and held by the second friction-fit gripper member 40. The thus grabbed bottle 41 may then be transported to a different place, such as a bottle conveyor 42, a refrigerator, a sensor arrangement or something else, as for example requested and/or prompted to the clinical lab automation device 100 via the touch screen 61 as shown in FIG. 5a.

For localization via the camera 110, for subsequent tasks with respect to the touch screen 61, as well as for displacement in the displacement direction D with particular regards to the gripping elements 45, 46, it is referred to the explanations given with respect to FIGS. 1 and 2a, along with their effects.

One or more of the gripping elements 25, 26, 35, 36, 45, 46, 55, 56 of the respective gripper members 20, 30, 40, 50 may include a pad including rubber and/or foamed rubber at a side which faces the object 21, 31, 41, 51 to be engaged.

Even though the displacement of the gripping elements 25, 26, 35, 36, 45, 46, 55, 56 is emphasized with particular regards to the displacement direction D, it is understood that further displacements in one or more directions different and particularly perpendicular to the displacement direction D may be provided at the handling tool 10. Nevertheless, it is further understood that the displacement direction D particularly provides for relative displacement of the gripping elements 25, 26, 35, 36, 45, 46, 55, 56 with respect to one another, i.e. in a rather local coordinate system, meanwhile further movement of the gripping elements 25, 26, 35, 36, 45, 46, 55, 56 in the three-dimensional space is particularly provided by the clinical lab automation device 100 having robot arm 90 with robot arm segments 91, i.e. in a rather global coordinate system.

Furthermore, it is emphasized that one or more of the objects 21, 31, 41, 51 in the clinical lab environment may have a unique identifier, such as a color sign, a barcode, a QR code, a RFID chip, etc., which may particularly be readable by the camera 110, by a sensor included to the handling tool 10, and/or by the touch screen 61. The handling tool 10 may accordingly particularly provide for time-efficiently performing subsequent tasks and protocolling thereof, which accordingly increases the repeatability, and in turn increases the quality of tests and experiments conducted in a clinical lab environment with the help of the clinical lab automation device 100 and its handling tool 10.

### LIST OF REFERENCE NUMERALS

5 storage
10 handling tool
12 base
13 first base element
14 second base element
20 form-fit gripper member
21 sample tube
22, 23 cartridge
25, 26 gripping element (of the form-fit gripper member)
30 first friction-fit gripper member
31 sample rack
32 holding portion (of the sample rack)
33 sample slot
35, 36 gripping element (of the first friction-fit gripper member)
40 second friction-fit gripper member
41 bottle
42 bottle conveyor
45,46 gripping element (of the second friction-fit gripper member)
50 third friction-fit gripper member
51 container
52 holding portion (of the container)
55,56 gripping element (of the third friction-fit gripper member)
60 touch screen input member
61 touch screen
65 tip
70 state-change member
71 tray
75,76 engagement finger
90 robot arm
91 robot arm segment
95 distal robot arm segment
100 clinical lab automation device
110 camera
D displacement direction
F first direction
R rotational axis
S second direction

1. A handling tool for a clinical lab automation device, the handling tool comprising two or more of the following:
a form-fit gripper member for form-fit engaging and holding an object, particularly referred to as a first object;
at least one friction-fit gripper member for frictionally engaging and holding an object, particularly referred to as a second object;
a touch screen input member for inputting information into a touch screen; and
a state-change member for changing the state of an object, particularly referred to as a third object.

2. Handling tool according to claim 1, wherein the handling tool includes the form-fit-gripper member and the at least one friction-fit gripper member, wherein the form-fit-gripper member and the friction-fit gripper member protrude from a base of the handling tool in step-wise manner.

3. Handling tool according to claim 1, including
a first friction-fit gripper member for frictionally engaging and holding the second object at substantially parallel side wall portions; and/or
a second friction-fit gripper member for frictionally engaging and holding the second object at substantially curved side wall portions; and/or
a third friction-fit gripper member for frictionally engaging and holding the second object at substantially flat inclined side wall portions.

4. Handling tool according to claim 3, wherein the handling tool includes two or more of the first, second and third friction-fit gripper members,
wherein an upper face of one of the first, second and third friction-fit gripper members and a lower face of another of the first, second and third friction-fit gripper members form a further gripper member for engaging with a further object.

5. Handling tool according to claim 1, wherein the touch screen input member comprises a resilient and/or conductive touching tip and/or a capacitively detectable tip at its distal end,
wherein the touch screen input member optionally is slidably disposed in one of the form-fit gripper member, the friction-fit gripper member and the state-change member.

6. Handling tool according to claim 1, wherein the state-change member includes an engagement finger,
wherein the state-change member is configured to change an open state of the third object to a closed state of the third object, or for changing the closed state of the third object to the open state of the third object, and
wherein the state-change member optionally protrudes from one of the form-fit gripper member and the friction-fit gripper member.

7. Handling tool according to claim 1, wherein the friction-fit gripper member has a pad including rubber or foamed rubber at a side which faces the object to be engaged.

8. Handling tool according to claim 1, wherein the form-fit gripper member is configured to engage the first object along a displacement direction of the form-fit gripper member, and to provide a form-fit with the first object in a direction substantially perpendicular to the displacement direction of the form-fit gripper member,
particularly while allowing a rotation of the first object about the direction in which the form-fit gripper member provides the form-fit in an engaged state of the form-fit gripper member.

9. Handling tool according to claim 1, wherein the form-fit gripper member includes a first pair of opposing gripping elements, wherein each gripping element of the first pair of opposing gripping elements has a semi-circular recess at a side facing the other gripping element of the first pair of opposing gripping elements,
wherein the gripping elements of the first pair of opposing gripping elements are displaceable relative to one another.

10. Handling tool according to claim 3, wherein the first friction-fit gripper member includes a second pair of opposing gripping elements, wherein the gripping elements of the second pair of opposing gripping elements have substantially parallel faces facing each other.

11. Handling tool according to claim 3, wherein the second friction-fit gripper member includes a third pair of opposing gripping elements, wherein the gripping elements of the third pair of opposing gripping elements are curved, so as to at least partially surround the second object in an engaged state of the second friction-fit gripper member.

12. Handling tool according to claim 3, wherein the third friction-fit gripper member includes a fourth pair of opposing gripping elements, wherein the gripping elements of the fourth pair of opposing gripping elements are inclined, such that a distance between the opposing gripping elements of the fourth pair of opposing gripping elements increases toward a tip of the gripping elements.

13. Handling tool according to claim 1, wherein the handling tool includes two or more gripper members, and wherein the two or more gripper members are displaceable in the substantially same direction.

14. Handling tool according to claim 1, wherein the handling tool includes two or more gripper members, and wherein the two or more gripper members are displaceably actuated by the same actuator.

15. Clinical lab automation device comprising:
a robot arm having a plurality of robot arm segments, wherein the robot arm segments are connected to one another via joints;
a handling tool according to claim 1, wherein the handling tool is connected to the distal robot arm segment of the robot arm.

16. Clinical lab automation device according to claim 15, the clinical lab automation device further comprising:
a camera for monitoring the handling tool, wherein the camera is independently movable relative to the handling tool.

17. Clinical lab automation device according to claim 15, wherein the clinical lab automation device is configured to hold at least one object with at least one of the form-fit gripper member and the friction-fit gripper member,
while inputting information to a touch screen via the touch screen input member, and/or while changing a state of the third object via the state-change member.
